(19) United States
(12) Patent Application Publication
(10) Pub. No.: US 2026/0012562 A1
(43) Pub. Date: Jan. 8, 2026

(54) METHODS EXECUTED BY ELECTRONIC DEVICES, ELECTRONIC DEVICES, STORAGE MEDIA, AND PROGRAM PRODUCTS

(71) Applicant: SAMSUNG ELECTRONICS CO., LTD., Suwon-si (KR)

(72) Inventors: Hao WANG, Beijing (CN); Weiming LI, Beijing (CN); Soonyong CHO, Suwon-si (KR); Qiang WANG, Beijing (CN); Younghun SUNG, Suwon-si (KR)

(73) Assignee: SAMSUNG ELECTRONICS CO., LTD., Suwon-si (KR)

(21) Appl. No.: 19/259,154

(22) Filed: Jul. 3, 2025

(30) Foreign Application Priority Data
Jul. 3, 2024 (CN) 2024 10889630.2
Jan. 3, 2025 (KR) 10-2025-0001167

(51) Int. Cl. H04N 13/111; H04N 13/00; H04N 13/128; H04N 13/271

(52) U.S. Cl. CPC H04N 13/111; H04N 13/128; H04N 13/271; H04N 2013/0081; H04N 2013/0085

(57) ABSTRACT

A extended reality (XR) processing method includes acquiring a binocular image including a left-eye image including at least one of a first image and a first depth map, and a right-eye image including at least one of a second image and a second depth map, generating a third depth map based on the left-eye image and a correlation between the left-eye image and the right-eye image, and generating a fourth depth map based on the right-eye image and the correlation between the left-eye image and the right-eye image, and performing extended reality (XR) processing on the binocular image based on the third depth map and the fourth depth map, wherein a resolution of the third depth map is greater than a resolution of the first depth map, and a resolution of the fourth depth map is greater than a resolution of the second depth map.

### CROSS-REFERENCE TO RELATED APPLICATION

This application is based on and claims priority under 35 U.S.C. § 119 to Chinese Patent Application No. 202410889630.2, filed on Jul. 3, 2024, in the State Intellectual Property Office and Korean Patent Application No. 10-2025-0001167, filed on Jan. 3, 2025, in the Korean Intellectual Property Office, the disclosures of which are incorporated by reference herein in their entirety.

### BACKGROUND

### 1. Field

The disclosure relates to the field of Extended Reality (XR) technology, and in particular, to methods executed by electronic devices, electronic devices, storage media, and program products for processing on binocular images.

### 2. Description of the Related Art

In three-dimensional (3D) environmental recognition, depth information is one of the key information of Extended Reality (XR) technology. XR systems require high-precision real-time processing and understanding of the depth of real-world scenarios to provide users with smooth, high-quality, and very realistic XR effects.

In related art XR systems, depth information is processed by focusing only on monocular input. Therefore, when the related art technology is extended to an XR device equipped with binocular input, the depth space of both eyes does not match. As such, there is a need to enhance the processing of depth information to prevent the problem of binocular depth space mismatch.

### SUMMARY

According to an aspect of the disclosure, there is provided a method performed by an electronic device, the method including: acquiring a binocular image including a left-eye image and a right-eye image, the left-eye image including at least one of a first image and a first depth map, and the right-eye image including at least one of a second image and a second depth map; generating a third depth map based on the left-eye image and a correlation between the left-eye image and the right-eye image, and generating a fourth depth map based on the right-eye image and the correlation between the left-eye image and the right-eye image; and performing extended reality (XR) processing on the binocular image based on the third depth map and the fourth depth map, wherein a resolution of the third depth map is greater than a resolution of the first depth map, and a resolution of the fourth depth map is greater than a resolution of the second depth map.

According to another aspect of the disclosure, there is provided an electronic device including: memory storing one or more instructions, and a processor configured to execute the one or more instructions, wherein the one or more instructions, when executed by the processor, configured to: acquire a binocular image including a left-eye image and a right-eye image, the left-eye image including at least one of a first image and a first depth map, and the right-eye image including at least one of a second image and a second depth map; generate a third depth map based on the left-eye image and a correlation between the left-eye image and the right-eye image, and generating a fourth depth map based on the right-eye image and the correlation between the left-eye image and the right-eye image; and perform extended reality (XR) processing on the binocular image based on the third depth map and the fourth depth map, wherein a resolution of the third depth map is greater than a resolution of the first depth map, and a resolution of the fourth depth map is greater than a resolution of the second depth map.

According to an aspect of the disclosure, there is provided a non-transitory computer readable storage medium having a computer program stored thereon, the computer program executed by a processor configured to implement a method including: acquiring a binocular image including a left-eye image and a right-eye image, the left-eye image including at least one of a first image and a first depth map, and the right-eye image including at least one of a second image and a second depth map; generating a third depth map based on the left-eye image and a correlation between the left-eye image and the right-eye image, and generating a fourth depth map based on the right-eye image and the correlation between the left-eye image and the right-eye image; and performing extended reality (XR) processing on the binocular image based on the third depth map and the fourth depth map, wherein a resolution of the third depth map is greater than a resolution of the first depth map, and a resolution of the fourth depth map is greater than a resolution of the second depth map.

According to one or more embodiments of the disclosure, binocular input may be processed simultaneously, and ultra-high-resolution of the binocular depth map is implemented by using the interaction of cross-view correlation between the left-eye image and the right-eye image. Therefore, a high-resolution binocular depth map is output, the binocular depth quality of an XR device of binocular input is improved, and simultaneously binocular consistency is ensured.

### BRIEF DESCRIPTION OF DRAWINGS

The above and other aspects, features, and advantages of certain embodiments of the disclosure will be more apparent from the following description taken in conjunction with the accompanying drawings, in which:

In order to more clearly describe the features and aspects of the embodiments of the disclosure, hereinafter, the accompanying drawings necessary for describing the embodiments of the disclosure will be briefly introduced.

FIG. 1 is a flowchart of a method executed by an electronic device according to an embodiment;

FIG. 2 is a schematic diagram of an Extended Reality (XR) device that collects binocular images according to an embodiment;

FIG. 3 is a schematic diagram of a process flow of a binocular depth super-resolution (BDSR) module according to an embodiment;

FIG. 4 is a schematic diagram of a BDSR module according to an embodiment;

FIG. 5 is a schematic diagram of a cross-attention network model according to an embodiment;

FIG. 6 is a schematic diagram of another cross-attention network model according to an embodiment;

FIG. 7 is a schematic diagram of a cross-attention network learning process according to an embodiment;

FIG. 8 is a schematic diagram of a guide-based cross-attention network model according to an embodiment;

FIG. 9 is a schematic diagram of a guide-based local cross-attention network model according to an embodiment;

FIG. 10 is a schematic diagram of a process flow of a binocular real depth super-resolution (BRDSR) module according to an embodiment;

FIG. 11A is a schematic diagram of a multi-frame dynamic feature fusion according to an embodiment;

FIG. 11B is a schematic diagram of another multi-frame dynamic feature fusion according to an embodiment;

FIG. 12A is a schematic diagram of a BRDSR module task according to an embodiment;

FIG. 12B is a schematic diagram of a process flow of a BVDSR module according to an embodiment;

FIG. 13 is a schematic diagram of a feature flow-based video depth super-resolution model according to an embodiment;

FIG. 14 is a schematic diagram of another feature flow-based video depth super-resolution model according to an embodiment;

FIG. 15 is a schematic diagram of a video depth super-resolution model based on a space-time depth decoder module according to an embodiment;

FIG. 16 is a schematic diagram of a video depth super-resolution model in which an extrapolation module is combined according to an embodiment;

FIG. 17 is a schematic diagram of a video depth super-resolution model in which another extrapolation module is combined according to an embodiment;

FIG. 18 is a schematic diagram of a depth super-resolution method for an XR device according to an embodiment;

FIG. 19 is a schematic diagram of an application scenario 1 of an XR system according to an embodiment;

FIG. 20 is a schematic diagram of an application scenario 2 of an XR system according to an embodiment; and

FIG. 21 is a structural diagram of an electronic device according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

Hereinafter, a thorough understanding of various embodiments of the disclosure defined by the claims and equivalents thereof will be described with reference to the accompanying drawings. In the description, various specific details are included to help understanding, but these are to be regarded as illustrative. Accordingly, one of ordinary skill in the art may understand that various embodiments according to the disclosure may be variously changed and modified without departing from the scope and spirit of the disclosure. In addition, descriptions of known functions and structures may be omitted for clarity and brevity.

The terms and phrases used in the disclosure are not limited to their dictionary meanings, and are only used to help clear understanding and consistent understanding of the disclosure. Accordingly, those skilled in the art will clearly understand that the following description of various embodiments of the disclosure is provided for purposes of explanation only and is not intended to limit the scope of the disclosure as defined by the appended claims and their equivalents.

It is noted that the singular “a”, “one”, and “the” may also include plural referents unless the context clearly indicates otherwise. Thus, references to a “member surface,” for example, include references to one or more such surfaces. When one element is described as “connected” or “coupled” to another element, this may mean that the one element is directly connected or coupled to another element, or may mean that the one element and the other element constitute a connection relationship by an intermediate element. In addition, the term “connection” or “combination” used herein may include a wireless connection or a wireless combination.

The term “include” or “may include” may mean the presence of a corresponding disclosed function, operation, or component that may be used in various embodiments of the disclosure, and does not limit the presence of one or more additional functions, operations, or features. In addition, the term “include” or “comprise” may be interpreted to mean the existence of a particular feature, number, step, action, component, component, or combination thereof, but may not be construed as excluding the possibility of the existence of one or more other features, numbers, steps, operation, component, or combinations thereof.

The term “or” used in various embodiments of the disclosure includes any listed terms and all combinations thereof. For example, “A or B” may contain A, may contain B, or may contain both A and B. When describing a plurality of items (two or more items}, if the relationship between the plurality of items is not clearly defined, the plurality of items may represent one, two or more, or all of the plurality of items. For example, the explanation that “parameter A includes A1, A2, and A3” may mean that parameter A may be implemented as including A1, A2, or A3, or parameter A may be implemented as including at least two of three items A1, A2, and A3.

Unless otherwise defined, all terms (including technical and scientific terms) used herein have the same meanings as those understood by those skilled in the art to which the disclosure belongs. General terms defined in the dictionary should be interpreted in a sense consistent with the context of the art and should not be interpreted ideally or overly formally unless explicitly defined in the disclosure.

At least some functions of a device or an electronic device according to the embodiments of the disclosure may be implemented through an artificial intelligence (AI) model. For example, at least one of a plurality of modules of a device or an electronic device may be implemented through an AI model. AI related functions may be performed through a nonvolatile memory, a volatile memory, and a processor.

The processor may include one or more processors. In this case, the one or more processors may be general-purpose processors such as central processing units (CPUs), application processors (APs), and the like, vision processing units (VPUs) such as graphics processing units (GPUs), visual processing units (VIPs), and the like, and/or an AI-dedicated processors such as neural processing units (NPUs).

The one or more processors control processing of input data based on a work rule or an AI model predefined in nonvolatile memory and volatile memory. Work rules or AI models predefined through training or learning are provided.

Here, providing through learning means applying a training algorithm to a plurality of pieces of training data to acquire predefined work rules or an AI model with desired characteristics. The learning may be executed in a device performing AI or an electronic device itself according to an embodiment, and/or may be implemented by a separate server/system.

The AI model may include multiple neural network layers. Each layer has multiple weights, and each layer performs neural network computation through computation between input data of that layer (e.g., calculation results of the previous layer and/or input data of the AI model) and multiple weights of the current layer. Examples of neural networks include, but are not limited to, convolutional neural networks (CNNs), deep neural networks (DNNs), recurrent neural networks (RNNs), restricted Boltzmann machines (RBMs), deep belief networks (DBNs), bidirectional recurrent deep neural networks (BRDNNs), generative adversarial networks (GANs), and deep Q networks.

A learning algorithm is a method of training a predetermined target device (e.g., a robot) by using a plurality of pieces of training data to make, allow, or control the target device to perform a decision or prediction. Examples of the learning algorithm include, but are not limited to, supervised learning, unsupervised learning, semi-supervised learning, or reinforcement learning.

The method according to the disclosure may relate to one or more of technical fields such as voice, language, image, video, or data intelligence.

According to an embodiment, in the case of sound or language fields, according to this disclosure, if there is a method executed by an electronic device that recognizes the user's voice and interprets the user's intention, a voice signal, which is an analog signal, may be collected through a collection device (e.g., a microphone), and the voice part is converted into computer-readable text using an automatic sound recognition (ASR) model. The user's utterance intention may be acquired by interpreting converted text using a natural language understanding (NLU) model. The ASR model or the NLU model may be an AI model. The AI model may be processed by an AI dedicated processor designed with a hardware structure designated for processing the AI model. AI models may be acquired through learning. Here, “acquiring through learning” means acquiring a predefined work rule or AI model configured to execute a desired feature (or purpose) by training a basic AI model with a plurality of pieces of learning data through a learning algorithm. Language comprehension is a technique used to recognize and apply/process human language/text, including natural language processing, machine translation, dialogue systems, and question answering or speech recognition/synthesis.

According to an embodiment, in the case of an image or video field, according to the disclosure, in a method executed by an electronic device, an image and/or its feature-related data may be used as input data for an AI model to acquire output data of the image or depth information, weights, and/or motion information within the image. The method of the disclosure may relate to the field of vision understanding of AI technology. Vision understanding is technology that recognizes and processes objects, as in human vision such as object recognition, object tracking, image search, human recognition, scenario recognition, 3D reconstruction/location, or image augmentation.

According to an embodiment, in the case of data intelligence processing fields, according to the disclosure, in a method executed by an electronic device, an AI model may be used to recommend, execute, or predict information such as weights, masks, etc. by using time sequences and/or image data combining binocular images of both eyes. The processor of the electronic device may perform a preprocessing operation on the data and convert the preprocessed data into a form suitable for use as an input of an AI model. Inference prediction is a technique that performs logical inference and prediction through information decision, and includes knowledge-based inference, optimization prediction, preference-based planning or recommendation.

In order to clarify the objective, features, aspects, and advantages of the disclosure, an implementation method of the disclosure will be described in more detail below with reference to the accompanying drawings.

In the related art XR systems, the processing of depth information is focused on monocular input. However, if the related art technology is applied to an XR device equipped with binocular input, the processing of binocular depth information may lead to mismatched depth spaces of both eyes, resulting in problems with depth loss or inaccurate regions. For example, depth acquired by depth sensors may be affected by various depth degradation, especially depth holes and noise caused by object materials (e.g., mirror metal, low-reflectivity surfaces, etc.). For example, in a case in which a real furniture table is included in an example scenario, and binocular depth information is collected and processed, the predicted depth value of the table surface in the scenario may not match due to factors such as parallax and depth hole between the left and right images. To this end, an embodiment of the disclosure proposes a method of processing online combination binocular depth information. The method is used to combine binocular inputs to improve depth quality and binocular consistency, thereby improving the robustness and adaptability of depth-based applications in XR systems.

Hereinafter, the features and/or aspects of the embodiment of the disclosure and the technical effect of the technical solution of the disclosure will be described with reference to some implementation methods. It should be noted that the following embodiments may be referenced, borrowed, or combined with each other, and other embodiments do not repeatedly describe the same terms, similar features, and similar implementation operations.

According to an embodiment of the disclosure, provided is a method executed by an electronic device.

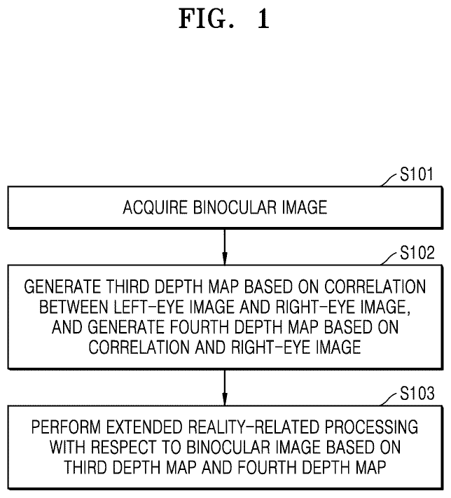

Referring to FIG. 1, in operation S101, the method according to an embodiment may include acquiring binocular images. A left-eye image in the binocular image may include a first image and/or a first depth map, and a right-eye image in the binocular image may include a second image and/or a second depth map.

In an embodiment, a binocular image may include, but is not limited to, a left-eye image and a right-eye image. In the following, all arbitrary data related to both eyes may be understood as data related to the left-eye and data related to the right-eye, and it may be understood that similar meanings may not be repeatedly explained.

In an embodiment, the first image and the second image may be high-resolution color images or high-resolution gray scale images. The high-resolution color images may include, but is not limited to, red, green, blue (RGB) images. The first depth map and the second depth map may mean a low-resolution and/or incomplete depth map, and may be, for example, a cavity, noise and/or distorted depth map due to deterioration of collection on the real world. In an example case in which an RGB image and a depth map are included in a binocular image, the binocular image may be referred to as a binocular color depth (RGBD) image.

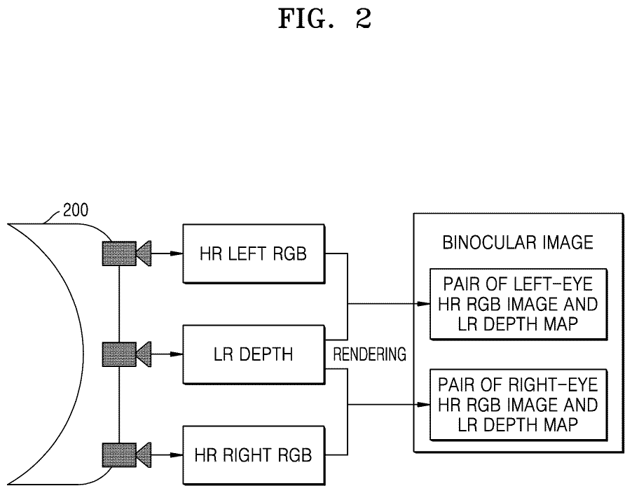

In an embodiment, the binocular image may be collected using a device including a plurality of sensors. The plurality of sensors may include, but is not limited to, an image sensor, a depth sensor, etc. For example, as shown in FIG. 2, an XR device 200 may include at least two RGB cameras (e.g., a binocular camera that may correspond to the left-eye and the right-eye, respectively) and at least one depth camera. According to an embodiment, using the XR device 200 including the at least two RGB cameras and the at least one depth camera, a high-resolution (HR) left RGB residue image, an HR right RGB image, and a low-resolution (LR) depth map are collected, respectively. According to an embodiment, a pair of a left-eye HR RGB image and a left-eye LR depth map are acquired by processing (or rendering) the HR left RGB image and the LR depth map, and a pair of a right-eye HR RGB image and a right-eye LR depth map are acquired by processing (or rendering) the HR right RGB image and the LR depth map. For example, the pair of the left-eye HR RGB image and the left-eye LR depth map and the pair of the right-eye HR RGB image and the right-eye LR depth map may be acquired using a splatting technique, but the disclosure is not limited thereto. Accordingly, the pair of a left-eye HR RGB image and a left-eye LR depth map and the pair of a right-eye HR RGB image and a right-eye LR depth map may be input and processed as a binocular image according to embodiments.

For example, the XR device 200 may be a head mounted XR device, and, in an example scenario, a user may move and/or rotate by wearing the head mounted XR device, and collect the image through a plurality of cameras on the head mounted XR device. According to an embodiment, the XR device may be an XR device of a different usage method. According to an embodiment, the rendering process may be executed directly by the XR device. However, the disclosure is not limited thereto, and as such, according to another embodiment, the rendering process may be transferred (or transmitted) from the XR device to another device to be executed. For example, the other device may include, but is not limited to, smartphones, tablet personal computers (PCs), laptop PCs, desktop PCs, other smart wearable devices (e.g., watches, clothing, etc.), smart TVs, and as other examples, the devices include, but are not limited to, independent physical servers, server clusters, distributed systems, or cloud servers.

Referring to FIG. 1, in operation S102, the method according to an embodiment may include generating a third depth map based on the left-eye image and a correlation between the left-eye image and the right-eye image, and generating a fourth depth map based on the right-eye image and the correlation between the left-eye image and the right-eye image. Here, a resolution of the third depth map is greater than a resolution of the first depth map, and a resolution of the fourth depth map is greater than a resolution of the second depth map.

In an embodiment, by introducing a module that may combine a left-eye view and a right-eye view, an interaction of the binocular image with high efficiency may be effectively supported. Moreover, by implementing or adopting, as at least a basis, a correlation between the left-eye image and the right-eye image, including, but not limited to, a correspondence relationship, a semantic relationship, a spatial relationship, and a fusion relationship, to generate a third depth map and a fourth depth map, the consistency of the generated binocular depth map may be ensured. Here, the third depth map and the fourth depth map may refer to high-resolution and/or complete depth maps. The output third and fourth depth maps have excellent depth quality and play a major role in optimizing the performance of downstream tasks (e.g., processing related to XR).

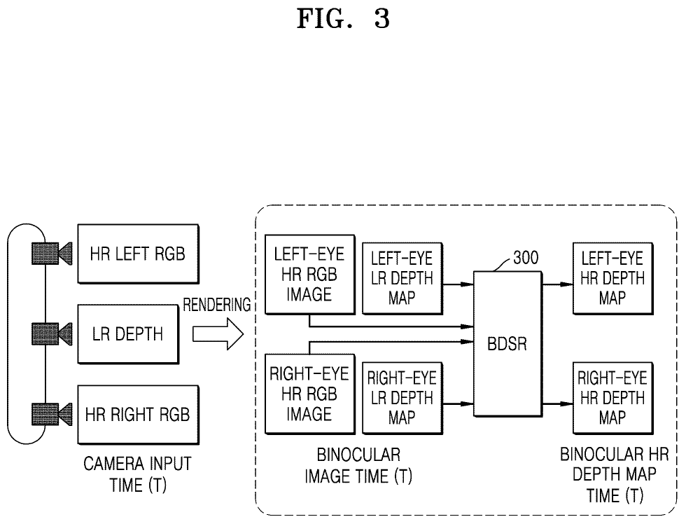

According to an embodiment, in the case of XR, the module may be referred to as a binocular depth super-resolution (BDSR) module 300 as illustrated in FIG. 3. For example, a process flow, as shown in FIG. 3, may include processing (or rendering) the HR left RGB image, HR right RGB image, and LR depth map collected at time T to acquire a pair of a left-eye HR RGB image (e.g., a first image) and a left-eye LR depth map (e.g., a first depth map), and a pair of a right-eye HR RGB image (e.g., a second image) and a right-eye LR depth map (e.g., a second depth map), and inputting the pair of the left-eye HR RGB image and the left-eye LR depth map, and the pair of the right-eye HR RGB image and the right-eye LR depth map into BDSR module 400 to be processed. The BDSR module 300 combines binocular views to implement super-resolution for depth maps, and may output binocular HR depth maps (e.g., third depth maps and fourth depth maps) at time T. The BDSR module 300 may further perform depth map supplementation.

Referring to FIG. 1, in operation S103, the method according to an embodiment may include performing XR-related processing on the binocular image based on the third depth map and the fourth depth map.

According to an embodiment, binocular input may be processed simultaneously, and by implementing the super-resolution of the binocular depth map using the interaction of the cross-view between the left-eye image and the right-eye image, a super-resolution binocular depth map may be output, the binocular depth quality of the XR device of the binocular input may be improved, and binocular consistency may be ensured.

Here, XR may also be referred to as additional reality or artificial reality, including, but not limited to, augmented reality (AR), virtual reality (VR), mixed reality (MR), and the like. This may be understood as a generic term for these various items, for example, an AR device may be referred to as an XR device. That is, XR content may include fully generated content, or content in which generated content and captured content (e.g., photos or videos of the real world) are combined with each other.

In an embodiment, the XR-related processing includes at least one of the following processes, but is not limited thereto.

(1) AR processing: Virtual information superimposed on the real world is displayed, and real and virtual scenarios are combined with each other.

(2) MR processing: Real and virtual worlds are mixed together to create a new visual environment, while real objects and virtual information are included.

(3) Video See-Through (VST) processing: Passthrough technology is provided to collect the real environment, convert the collected real environment into a digital screen, and project the converted result back into a required view.

(4) VR fusion processing: Virtual fusion technology may more practically combine virtual objects with the real environment and support real-time interaction.

The binocular depth map in which high-resolution, high-quality views match according to an embodiment is very important in acquiring a real-life customized experience using the XR device. For example, in one scenario, a virtual character may be displayed in an actual scenario, and according to an embodiment, the virtual character may form an accurate shielding standing behind actual furniture according to an accurate depth. In another scenario, the improved VST technology based on an embodiment may form a passthrough effect with accurate depth, such as non-virtualization, non-transformation, non-distortion, and non-transposition.

According to an embodiment, in operation S102, the method may include, but is not limited to, additional operations as follows.

For example, the method of operation S102 may include acquiring a left-eye feature by performing feature extraction on the left-eye image, and acquiring a right-eye feature by performing feature extraction on the right-eye image.

According to an embodiment, the method of operation S102 may include acquiring an attention weight using a cross-attention network based on the left-eye feature and the right-eye feature. For example, the attention weight may be acquired at least once using the cross-attention network based on the left-eye feature and the right-eye feature. However, the disclosure is not limited thereto, and as such, the method may include acquiring attention weights using the cross-attention network based on the left-eye feature and the right-eye feature a plurality of times. The attention weight may indicate or characterize a semantic relationship (or semantic relationships) between left-eye and right-eye images. Based on the attention weight, augmented processing is performed on each of the left-eye feature and the right-eye feature. For example, the method may include performing a first augmentation processing on the left-eye feature based on the attention weights to obtain an augmented left-eye feature and a second augmentation processing on the right-eye feature based on the attention weights to obtain an augmented right-eye feature.

According to an embodiment, the method of operation S102 may include generating the third depth map based on the left-eye feature subjected to the at least once augmentation process, and the fourth depth map is generated based on the right-eye feature subjected to the at least once augmentation process. For example, the method may include generating the third depth map based on the augmented left-eye feature, and generating the fourth depth map based on the augmented right-eye feature.

According to an embodiment, the BDSR module 300 may be configured using a binocular cross-attention network.

In an embodiment, configuring the cross-view correlation of the binocular image through the cross-attention weight has a remarkable effect on improving depth quality and binocular consistency.

According to an embodiment, the processing of the left-eye image and the right-eye image may specifically be the processing of binocular features (e.g., left-eye features and right-eye features) extracted from the left-eye image and the right-eye image. Hereinafter, the processing of the left-eye image and the right-eye image may be similar, and thus the description thereof is not repeatedly described.

According to an embodiment, using a binocular color depth image as an example, a left-eye color feature may be extracted from a left-eye color image, a left-eye depth feature may be extracted from a left-eye depth map, and a left-eye feature may be acquired by fusing the left-eye color feature and the left-eye depth feature, which may also be called a left-eye color depth feature. A right-eye color feature may be extracted from a right-eye color image, a right-eye depth feature may be extracted from a right-eye depth map, and a right-eye feature may be acquired by fusing the right-eye color feature and the right-eye depth feature, which may be referred to as a right-eye color depth feature. The left-eye color depth feature and the right-eye color depth feature may be combined and called a binocular color depth feature.

For example, the cross-attention network may capture semantic correlations between binocular features (e.g., left-eye features and right-eye features) extracted from the left-eye image and the right-eye image, augment the left-eye feature and the right-eye feature by fusing the semantic correlations, and then generate a high-resolution binocular depth map (e.g., a third depth map and a fourth depth map) based on the augmented features.

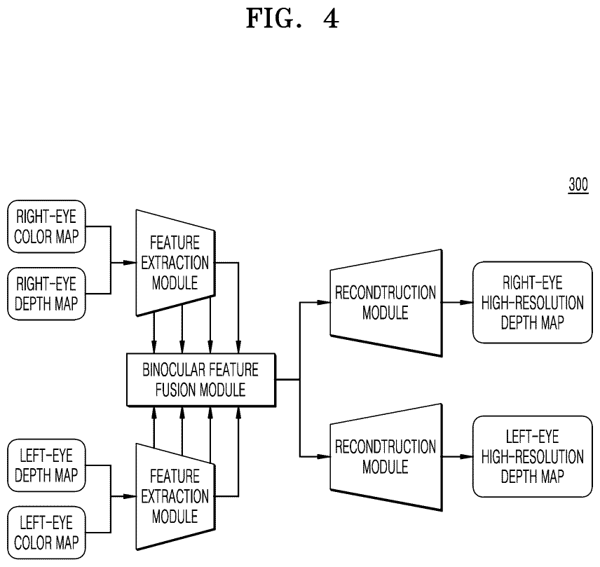

FIG. 4 is a schematic diagram of a BDSR module 300 according to an embodiment. According to an embodiment, the BDSR module 300 may implement a lightweight level binocular depth super-resolution model, which may run in real time. For example, as shown in FIG. 4, the BDSR model may include a feature extraction module (and a reconstruction module. For example, the feature extraction module may be a RGBD feature extraction module. The BDSR model may further include a binocular cross-attention network is added as a binocular feature fusion module to augment the features of left and right binocular images.

According to an embodiment, feature extraction is performed, through a feature extraction module, on the right-eye image (e.g., a right-eye color map and a second-depth map of the right-eye) and the left-eye image (e.g., a left-eye color map and a first-depth map of the left-eye), to acquire binocular features (e.g., left-eye features and right-eye features), both binocular features are input into a binocular feature fusion module, which performs augmented processing of the binocular features through cross-view correlation, and the augmented binocular features undergo a reconstruction module, which generates high-resolution binocular depth maps (e.g., third and fourth depth maps).

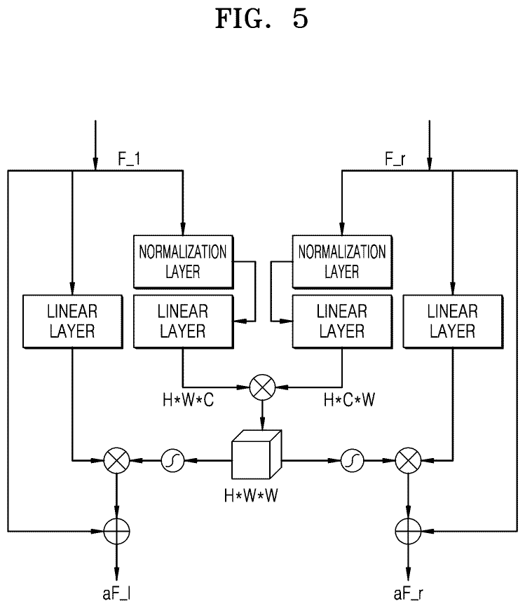

In an embodiment, the model architecture of one cross-attention network model (e.g., a binocular feature fusion module) may be as shown in FIG. 5. For example, the features of the left and right binocular images (e.g., the left-eye feature F_l and the right-eye feature F_r) are input to a normalization layer and a linear layer, respectively (e.g., the output dimensions are H*W*C and H*C*W, respectively), and then fusion is performed on the output from the linear layers to acquire attention weights (e.g., the dimensions are H*W*W). The attention weights are passed through the softmax function or the attention weights are normalized using the softmax function. After passing through the softmax function, the attention weights are fused with the results of the left-eye feature F_l through the linear layer and the results of the right-eye feature F_r through another linear layer, respectively, to augment the two fused results, and output the augmented binocular features aF_l and aF_r.

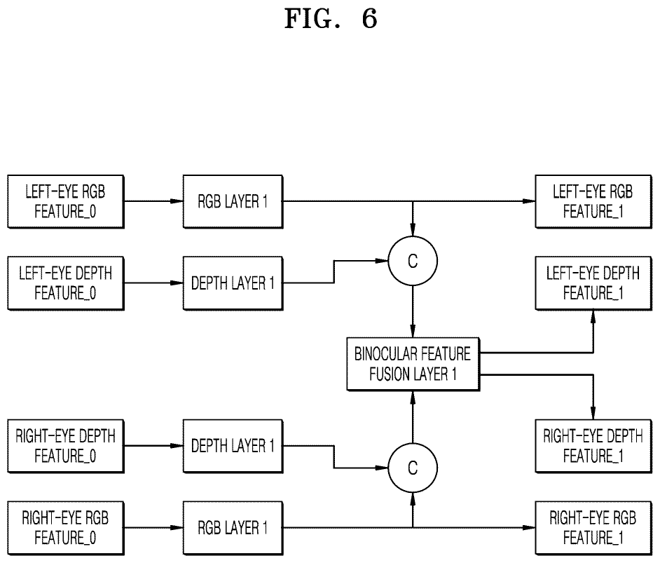

In an embodiment, one cross-attention network (e.g., a binocular feature fusion module) may include a plurality of network layers. FIG. 6 illustrates an example embodiment of a first layer of the cross-attention network. For example, as shown in FIG. 6, taking a left-eye branch as an example, a left-eye RGB feature_0 is processed by RGB layer 1 and left-eye RGB feature_1 is output, left-eye depth feature_0 is processed by depth layer 1 and output feature is output, and the output feature and left-eye RGB feature_1 are fused (e.g., connected “C”) and input to binocular feature fusion layer 1. Here, the binocular feature fusion layer 1 fuses the inputs of the left-eye branches, augments left-eye depth feature_0, and outputs left-eye depth feature_1. The process flow of the right-eye branch is similar, and the process flows processes of other network layers may be implemented or performed in the same or similar manner. The last network layer may output the augmented binocular feature.

In an embodiment, the cross-attention network may be trained based on at least one of the following loss functions: a loss function related to the consistency of the third depth map and the fourth depth map (which may be referred to herein as “loss 1”), and a loss function related to the consistency of the left-eye feature and the right-eye feature (which may be referred to herein as “loss 2”). These loss functions may be used as indicators of consistency measurements and are used to evaluate binocular consistency of predicted left and right depths. Here, the smaller the error, the greater consistency of the predicted binocular depth.

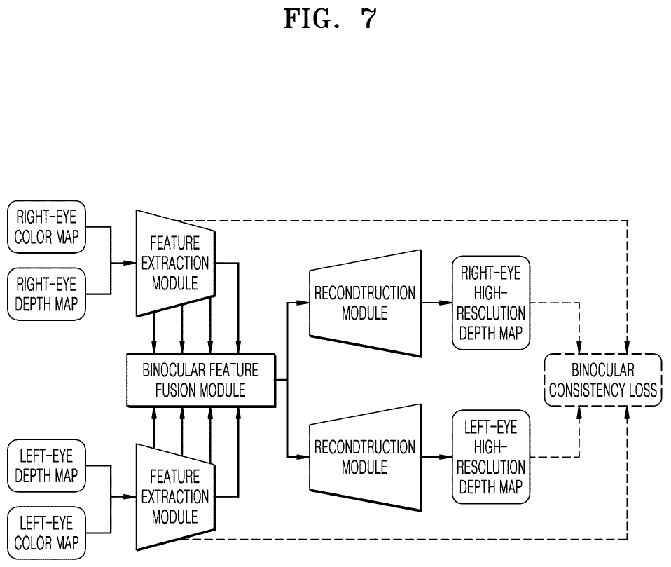

For example, in the learning process of cross-attention networks (e.g., binocular feature fusion modules), as illustrated in FIG. 7, the training method for training binocular consistency is to add the binocular consistency loss function (e.g., loss 1) to the output binocular depth map. According to an embodiment, a binocular coherence loss function (e.g., loss 2) is added to the binocular features extracted from the binocular feature extraction module. According to an embodiment, the binocular consistency of the cross-attention network is trained by using the loss 1 and the loss 2 simultaneously.

According to an embodiment, loss 1 may be expressed by the following formula.

$${L}_{s c} = {Mask}_{D} * ‖ {Warp}_{L \to D} ( {Depth}_{L} ) - {Warp}_{R \to D} ( {Depth}_{R} ) ‖$$

According to an embodiment, loss 2 may be expressed by the following formula.

$${L}_{s {c}_{-} f} = {Mask}_{D} * ‖ {Warp}_{L \to D} ( {Feature}_{L} ) - {Warp}_{R \to D} ( {Feature}_{R} ) ‖$$

Here, Mask_{D} represents the region with the depth value, Warp_{L→D}(Depth_{L}) represents the location where the depth value predicted from the left-eye is mapped to the depth sensor, Warp_{R→D}(Depth_{R}) represents the location where the depth value predicted from the right-eye is mapped to the depth sensor, Warp_{L→D}(Feature_{L}) represents the location where the feature value of the left-eye is matched to the depth sensor, and Warp_{R→D}(Feature_{R}) represents the location where the feature value of the right-eye is mapped to the depth sensor.

In an embodiment, the binocular consistency loss function may be used to guide the binocular depth output and/or binocular features to improve the consistency of the binocular estimation of the model.

In an embodiment, the process of determining the attention weight of the left-eye image and the right-eye image using the cross-attention network once and performing augmented processing on the left-eye image and the right-eye image based on the attention weight may include the following operations.

According to an example, the process of determining the attention weight of the left-eye image and the right-eye image may include determining a first related pixel from a left-eye feature based on a second depth map and/or the right-eye parallax map, acquiring a first related feature based on the determined first related pixel, determining a second related pixel from a right-eye feature based on a first depth map and/or a left-eye parallax map, and acquiring a second related feature based on the determined second related pixel.

In an embodiment, the second depth map and the right-eye parallax map may be converted to each other, and the first depth map and the left-eye parallax map may be converted to each other. For example, the second depth map may be converted to the right-eye parallax map or vice versa, and the first depth map may be converted to the left-eye parallax map or vice versa. Using the input depth map (e.g., first depth map, or second depth map) and/or binocular parallax map a priori, the relevant pixels corresponding to each pixel point are self-adaptively sampled, and related features (e.g., first related pixels, or second related pixels) are acquired based on the sampled related pixels (e.g., first related features, or second related features) to perform subsequent attention calculations.

According to an embodiment, the process of determining the attention weight of the left-eye image and the right-eye image may further include acquiring a first attention weight using a cross-attention network based on the first related feature and the right-eye feature, and acquiring a second attention weight using the cross-attention network based on the second related feature and the left-eye feature.

In an embodiment, since the applied cross-attention network may be understood as a guide-based cross-attention network, each view may acquire additional suggestions or prompts from other views, better restoring depth details.

According to an embodiment, the method may include performing an augmentation process on the right-eye feature based on the first attention weight, and performing an augmentation process on the left-eye feature based on the second attention weight.

In an embodiment, it is possible to adaptively (e.g., self-adaptively), high-efficiently and effectively aggregate a cross-view multimode binocular image through cross-attention with the guide suggestions or prompts.

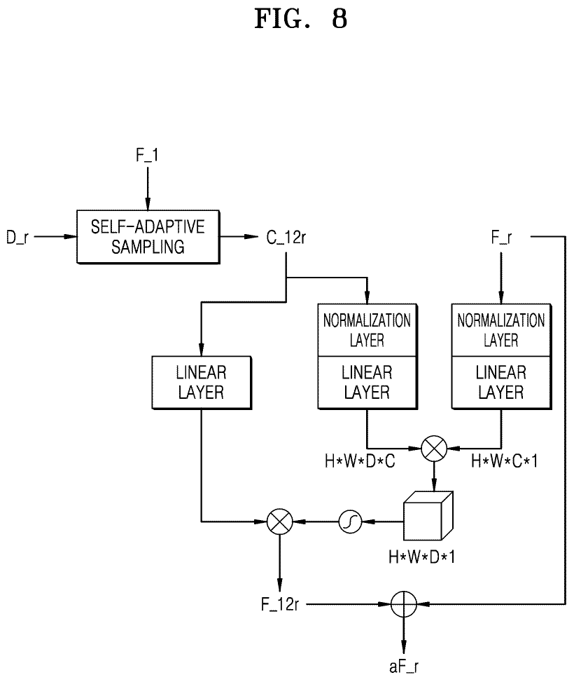

In an embodiment, the model architecture of the guide-based cross-attention network model may be as illustrated in FIG. 8. Specifically, taking augmentation of the right-eye feature F_r as an example, the second depth map D_r (a right-eye parallax map may be also provided) of the right-eye is used a priori, and a related pixel corresponding to each pixel point of the left-eye feature F_l is self-adaptively sampled, based on the sampled related pixels, a first related feature C_l2r is acquired, and the first related feature C_l2r and the right-eye feature F_r are fused after passing through the normalization layer and the linear layer (e.g., dimensions H*W*D*C and H*W*C*1, respectively) to acquire a first attention weight (e.g., dimension H*W*D*1, and the first attention weight is subjected to softmax function and fused with the result of the first related feature C_l2r after passing through the linear layer to acquire an attention result F_l2r, thereby augmenting the right-eye feature F_r, and outputting the augmented right-eye feature aF_r. The augmentation of the left-eye feature F_l may also be performed in the same or similar manner, and thus is not described further here.

According to an embodiment, the operation S203 may further include the following operations.

According to an embodiment, the operation S203 may further include determining a pixel non-shielding region of the right-eye feature based on the first attention weight, and determining a pixel non-shielding region of the left-eye feature based on the second attention weight.

According to an embodiment, the operation S203 may further include performing an augmentation process on the pixel non-shielding region of the right-eye feature based on the first attention weight, and preforming an augmentation process on the pixel non-shielding region of the left-eye feature based on the second attention weight.

In an embodiment, an uncertainty prediction is added, and the shielding situation of the defective pixels is predicted through the uncertainty to distinguish between pixel-shielded and pixel-unshielded regions, and the local augmentation operation is guided based on the prediction, wherein the pixel-shielded regions are not augmented and the pixel-unshielded regions are augmented.

In an embodiment, the applied cross-attention network may be understood as a guide-based local cross-attention network.

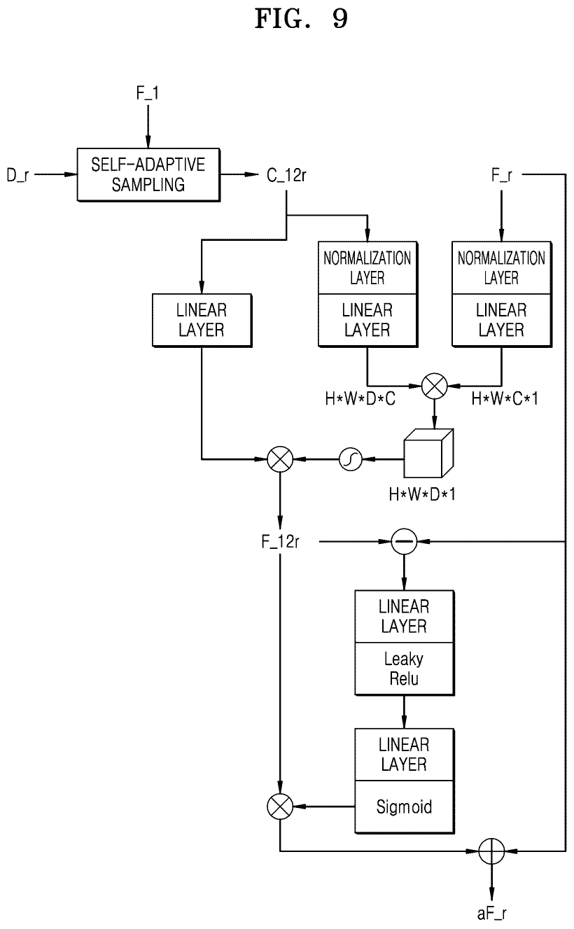

In an embodiment, the model architecture of the guide-based local cross-attention network model may be as illustrated in FIG. 9. Specifically, taking augmentation of the right-eye feature F_r as an example, the second depth map D_r (a parallax map may be also provided) of the right-eye is used a priori, and a related pixel corresponding to each pixel point of the left-eye feature F_l is self-adaptively sampled, based on the sampled related pixels, a first related feature C_l2r is acquired, and the first related feature C_l2r and the right-eye feature F_r are fused after passing through the normalization layer and the linear layer (e.g., dimensions H*W*D*C and H*W*C*1, respectively) to acquire a first attention weight (e.g., dimension H*W*D*1, and the first attention weight is subjected to softmax function, and fused with the result of the first related feature C_l2r after passing through the linear layer to acquire an attention result F_l2r. Based on the difference between the attention result F_l2r and the right-eye feature F_r, after passing through the linear layer and a Leaky Relu activation function and the linear layer and a Sigmoid activation function (where the quantity and type of the activation function layer may be replaced, and illustrated as an example here), a pixel non-shielding region of the right-eye feature F_r is acquired, and then is fused with the attention result F_l2r to augment the pixel non-shielding region of the right-eye feature F_r and output the augmented right-eye feature aF_r. The augmentation of the left-eye feature F_l may also performed in the same or similar manner, and thus further details may not be described here.

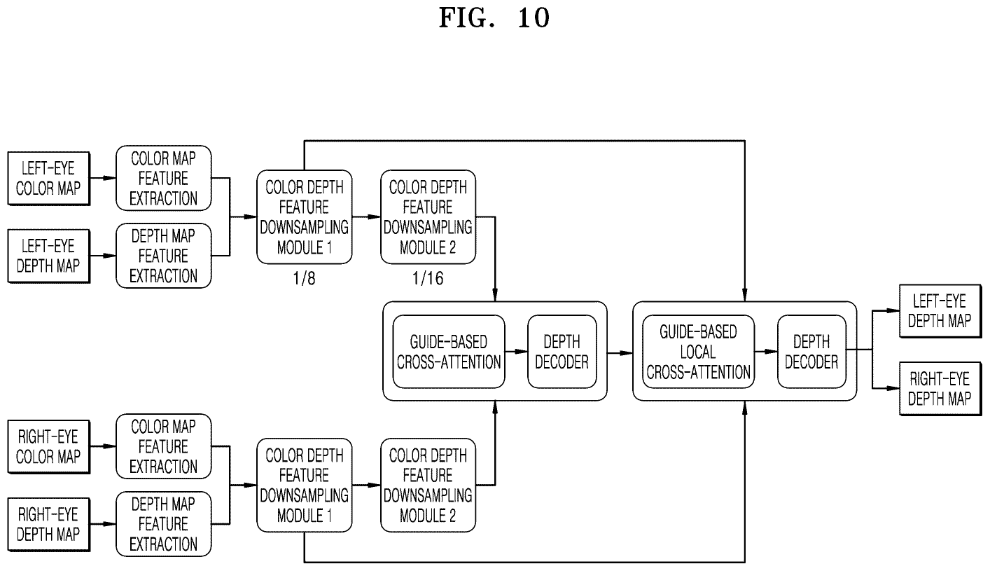

According to an embodiment, a guidance-based cross-attention network may be included in a binocular real depth super-resolution (BRDSR) module, which is a guidance-based binocular depth super-resolution model with a lightweight level that may run in real time. For example, the process flow of the BRDSR module may include, as illustrated in FIG. 10, extracting binocular features for each of the right-eye images (e.g., the right-eye color map and the right-eye second depth map) and the left-eye image (e.g., the left-eye color map and the left-eye first depth map), entering all binocular features into at least one color depth feature downsampling module (e.g., two color depth feature downsampling modules in FIG. 10), and outputting a high-resolution binocular depth map (e.g., a third depth map and a fourth depth map) as the binocular downsampling result after passing through at least one set of guide-based cross-attention networks and depth decoders. Here, the number of guide-based cross-attention networks used corresponds to the number of downsampling modules. According to an embodiment, the guide-based cross-attention network may be implemented solely based the model architecture shown in FIG. 8 (e.g., implement at least one model architecture), implemented solely the model architecture shown in FIG. 9 (e.g., implement at least one model architecture), or implemented based on a combination of the model architecture shown in FIG. 8 (e.g., at least one model architecture) and the model architecture shown in FIG. 9 (e.g., at least one model architecture) (e.g., FIG. 10 illustrates a cascade use of a guide-based cross-attention network as shown in FIG. 8 and a guide-based local cross-attention network as shown in FIG. 9). However, the disclosure is not limited thereto, and as such, the guide-based cross-attention network may be implemented in different manner.

In addition, the related art depth super-resolution method is not suitable for online XR applications due to many delays in the model because the related art depth super-resolution method implements depth super-resolution using past and future frames. In an example case in which depth super-resolution is performed using only past frames, the problem of time sequence mismatch in depth becomes more serious, especially in dynamic environments. Depth sequences due to time sequence mismatch directly affect user experience in downstream tasks and online processing.

In an embodiment, to simultaneously address time sequence inconsistency (e.g., depth inconsistency across two consecutive frames), binocular inconsistency (e.g., depth inconsistency of left and right views), and online application issues, an online binocular video (e.g., multi-frame image) depth super-resolution method is proposed, which considers binocular and time sequence consistency while retrieving past frames. Here, an online video processing method means not using future frames as inputs, and compared to the related art offline video processing method using future frames, the method according an embodiment may include acquiring a superior online experience using real-time video on an XR device.

According to an embodiment, the operation S102 may further include the following operations.

According to an embodiment, the operation S102 may further include generating a binocular feature of the current frame based on a correlation between a left-eye image and a right-eye image of a current frame, the left-eye image, and the right-eye image. The binocular feature includes a left-eye feature and a right-eye feature.

According to an embodiment, the binocular feature of the current frame may be the binocular feature output from the feature extraction module after inputting the binocular image of the current frame into the module shown in FIG. 4.

According to an embodiment, the binocular feature of the current frame may be the binocular feature output from the binocular feature fusion module after inputting the binocular image of the current frame into the module shown in FIG. 4.

According to an embodiment, the binocular feature of the current frame may be the augmented right-eye feature aF_r and/or the augmented left-eye feature aF_l, which are output after the binocular feature of the current frame passes through the network shown in FIG. 5, 8, or 9.

According to an embodiment, the binocular feature of the current frame may be the augmented binocular feature output from the guide-based cross-attention network or guide-based local cross-attention after the binocular image of the current frame is entered into the module shown in FIG. 10.

According to an embodiment, the binocular feature of the current frame may be extracted in a different manner.

Here, the binocular features extracted based on the correlation between binocular images help improve binocular consistency.

According to an embodiment, the operation S102 may further include determining motion information between a plurality of frames based on a binocular feature of at least one of the current frame and the frames prior to the current frame.

In an embodiment, the input to the operation for determining the motion information includes binocular features of multi-frames. According to an embodiment, binocular features of multiple frames may be stored in a memory bank and called when processing future frames, and newly extracted features of each frame (e.g., binocular features of the current frame) may also be updated in the memory bank. Here, the binocular feature of at least one past frame (e.g., at least one of the frames prior to the current frame) stored in the memory bank may be a binocular feature extracted directly from the binocular image, the augmented binocular feature, or the feature of the extracted first image and the feature of the extracted second image which are added to the feature of the binocular depth map acquired using the method of an operation to be described later. Embodiments of the disclosure are not limited thereto.

In an embodiment, there is no need to input color images between two frames, and motion information may be estimated based on direct features to better multiplex the extracted features.

According to an embodiment, the operation S102 may further include mapping, based on the motion information, binocular features of at least one frame among frames prior to the current frame to the current frame.

In an embodiment, the operation S103 may project a feature of a past frame (e.g., at least one of the frames prior to the current frame) to the current frame based on the trained motion information. Here, based on the motion and mapping of the feature flow, more accurate motion information may be acquired.

According to an embodiment, the operation S103 may further include generating the third depth map and the fourth depth map of the current frame, respectively, by fusing the binocular feature of at least one of the frames prior to the mapped current frame with the binocular feature of the current frame.

In an embodiment, fusion of dynamic features of multi-frames is performed, and the converted features of multiple frames are fused to generate a third depth map and a fourth depth map of the current frame. Here, adaptively (or self-adaptively) fusing the features of multi-frames helps to improve time sequence consistency.

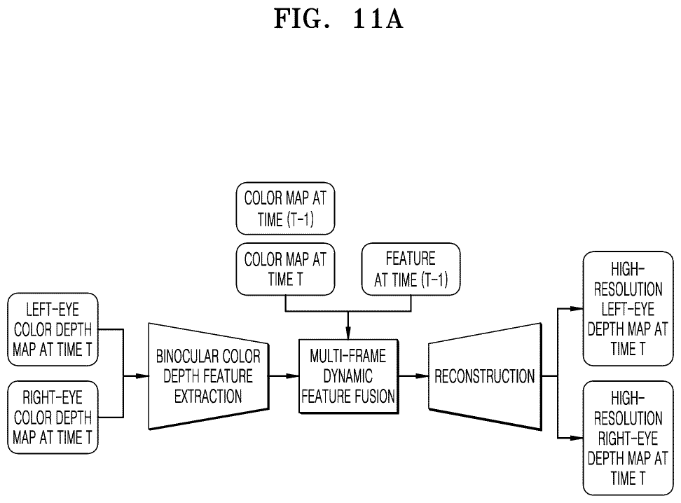

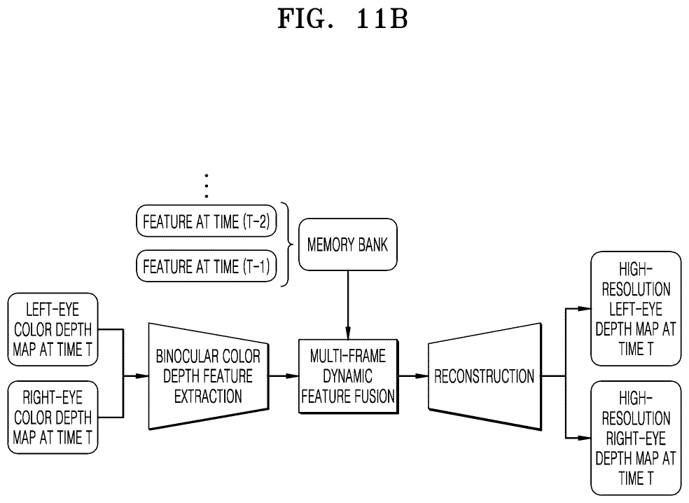

In an embodiment, when fusing a dynamic feature of multi-frames, the first image and the second image (e.g., an RGB image) of multiple frames may be combined. For example, as shown in FIG. 11A, the binocular color depth map features are extracted from the left-eye color depth map and the right-eye color depth map of the current frame (e.g., at time T), and then the dynamic features of multi-frames are fused along with the feature of the past frame (e.g., at time (T−1)), and the color maps of the past frame (e.g., at time (T−1) and the current frame (e.g., at time T), and the output features undergo depth reconstruction before acquiring a high-resolution binocular depth map of the current frame (e.g., at time T). As another example, in order to reduce network complexity and make full use of the extracted color depth feature information with higher efficiency, motion information between consecutive frames may be learned by relying only on extracted features instead of relying on depth maps, As shown in FIG. 11B, after extracting binocular color depth features from the left-eye color depth map and the right-eye color depth map of the current frame (e.g., at time T), fusion of dynamic features of multi-frames along with features of past frames (e.g., at time (T−1), time (T−2), . . . ) among memory banks is performed, and in an example case in which the feature flow of past frames and features of current frames are used as inputs, multi-frame information is fused with high efficiency and a high-resolution binocular depth map of the current frame (e.g., at time T) may be acquired after the depth of the output feature is reconstructed.

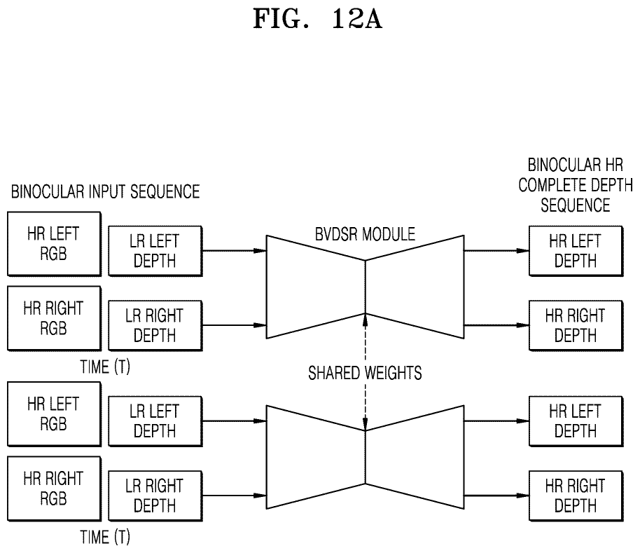

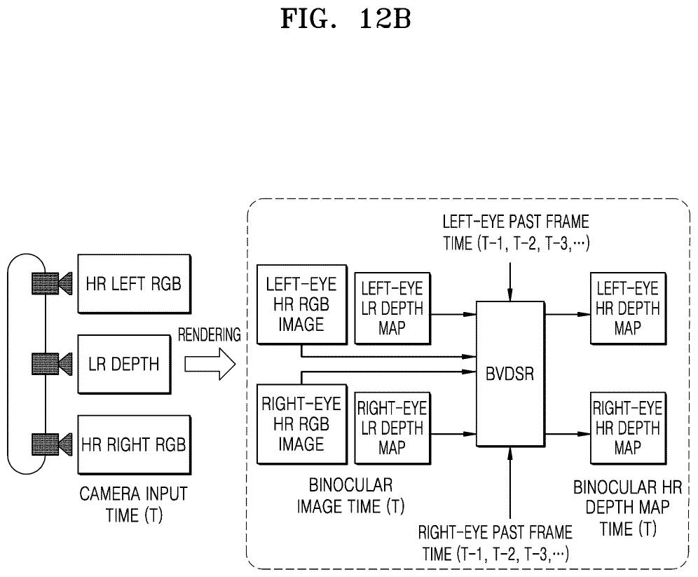

According to an embodiment, a binocular video depth super-resolution (BVDSR) module may perform the operations of generating a binocular feature of the current frame, determining motion information between a plurality of frames, mapping, based on the motion information, binocular features of at least one frame among frames prior to the current frame to the current frame, and generating the third depth map and the fourth depth map of the current frame, respectively, by fusing the binocular feature of at least one of the frames prior to the mapped current frame with the binocular feature of the current frame. For example, operations of the BVDSR module may be as illustrated in FIG. 12A. Based on the binocular high-resolution RGB image and the binocular low-resolution incomplete depth map sequence, the output of the binocular high-resolution full-depth map sequence is optimized.

For example, a process flow of the BVDSR module may be as illustrated in FIG. 12B. By processing (or rendering) the HR left RGB image, HR right RGB image, and LR depth map collected at time T, a pair of a left-eye HR RGB image and a left-eye LR depth map at time T, a pair of a right-eye HR RGB image and a right-eye LR depth map are acquired, and input to a BVDSR module then be processed (to WC: please check FIG. 12), and at the same time, left-eye and right-eye features of past frames (e.g., time T−1, T−2, T−3, . . . ) are input into the BVDSR module to then be processed, and then the BVDSR module combines multiple frames of binocular views to implement super-resolution for the depth map, and outputs a binocular HR depth map at time T.

In an embodiment, by providing a BVDSR model that interacts between cross-views and time sequences, it is possible to process binocular input time sequences without relying on future frames, which may maintain binocular consistency performance as well as ensure time sequence consistency of multiple frames.

In an embodiment, a basic online BVDSR module may be configured by extracting depth features for binocular colors from a BDSR module and combining a reconstruction decoder with time sequence fusion. Here, the model parameters of the BVDSR module may be reduced to a reference line, thereby making it a video processing model of one lightweight level.

In an embodiment, the method determining motion information between the plurality of frames based on the binocular feature of the at least one of the current frame and the frames prior to the current frame may include an operation of determining motion information of multiple frames based on binocular features of at least one of a current frame and frames prior to the current frames using an optical flow estimation network.

In an embodiment, motion information between consecutive frames is explicitly learned through the optical flow estimation network. Here, the optical flow estimation network is a feature-based motion information estimation network pre-trained in the embodiment, and by using a temporal change of a pixel and a correlation between consecutive frames in a feature sequence, a correspondence relationship between the past frame and the current frame may be found and motion information may be calculated.

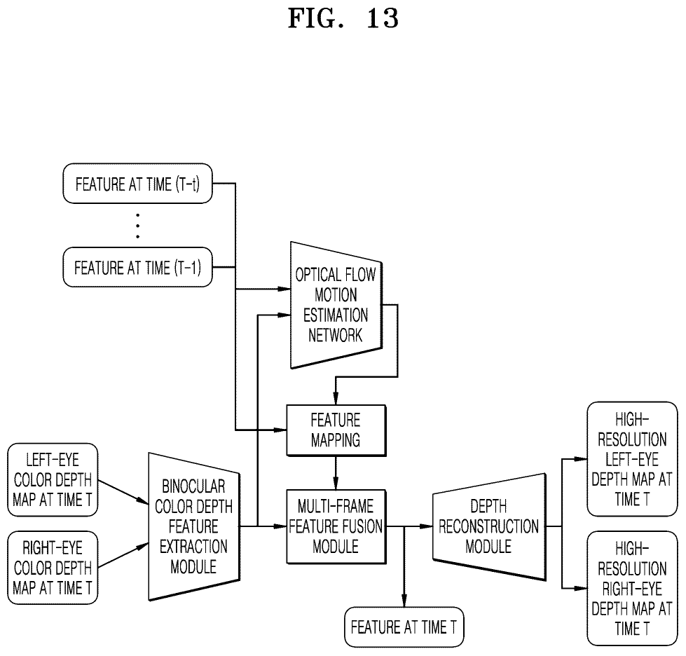

For example, in an embodiment, a lightweight level feature flow-based video depth super-resolution model capable of real-time driving may be provided, and as shown in FIG. 13, the model includes a module for extracting depth features for binocular colors (e.g., the feature extraction module and/or cross-attention network), an optical flow (e.g., motion or motion information) estimation network module, a multi-frame feature fusion module, and a depth reconstruction module. Specifically, feature extraction is performed for a current right-eye image (for example, a right-eye color map and a right-eye second depth map at time T) and a current left-eye image (for example, a left-eye color map and a left-eye first depth map at time T) through the binocular color depth feature extraction module to acquire a current binocular feature. After explicitly training the motion information between feature flows through the past features (e.g., features at time (T−1), . . . , features at time (T-t)) stored in the memory bank of multi-frames and optical flow estimation networks, multiple frame features are projected onto the current frame based on the trained motion information. After projection, dynamic fusion is performed for features after multi-frames are converted through a multi-frame feature fusion module, and the fused features may be updated in the memory bank, and a current high-resolution binocular depth map is output through a depth reconstruction module.

In an embodiment, the method determining motion information between the plurality of frames based on the binocular feature of the at least one of the current frame and the frames prior to the current frame may include an operation of determining motion information between multiple frames based on binocular features of at least one of a current frame and frames prior to the current frames using an implicit estimation network.

In an embodiment, motion information between consecutive frames is trained implicitly through an implicit estimation network, no supervised learning of optical flow or other motion information is required, and the motion information between frames is automatically trained through the design of the network.

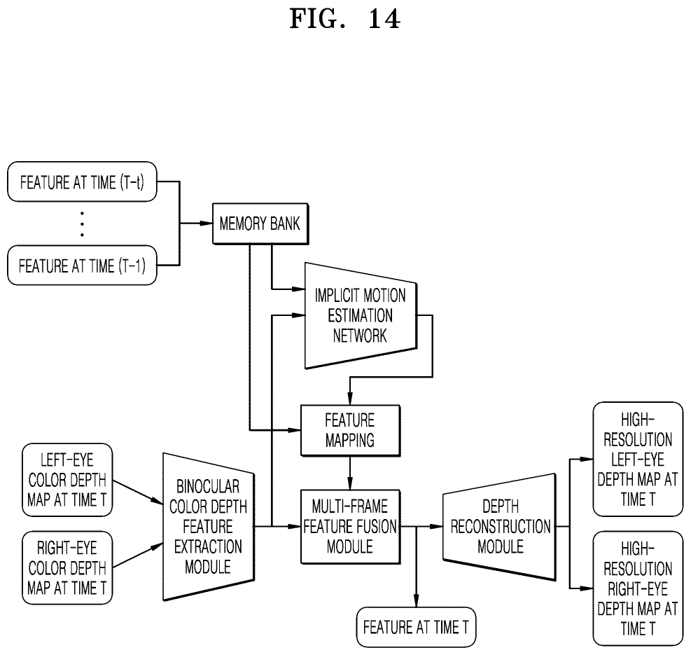

For example, in an embodiment, a lightweight level feature flow-based video depth super-resolution model capable of other real-time driving may be provided, and as shown in FIG. 14, the model includes a module for extracting depth features for binocular colors (e.g., the feature extraction module and/or cross-attention network), an implicit (e.g., motion or motion information) estimation network module, a multi-frame feature fusion module, and a depth reconstruction module. Specifically, feature extraction is performed for a current right-eye image (for example, a right-eye color map and a right-eye second depth map at time T) and a current left-eye image (for example, a left-eye color map and a left-eye first depth map at time T) through the binocular color depth feature extraction module to acquire a current binocular feature. After implicitly training the motion information between feature flows through the past features (e.g., features at time (T−1), . . . , features at time (T-t)) stored in the memory bank of multi-frames and implicit estimation networks, multiple frame features are projected onto the current frame based on the trained motion information. After projection, dynamic fusion is performed for features after multi-frames are converted through a multi-frame feature fusion module, and the fused features may be updated in the memory bank, and a current high-resolution binocular depth map is output through a depth reconstruction module.

For example, the multi-frame feature fusion module may self-adaptively aggregate dynamic and static features, and the BVDSR model may be acquired by adding a feature flow-based motion information estimation network and a multi-frame feature fusion module to the BDSR module or BRDSR module.

In an embodiment, the method of generating the third depth map and the fourth depth map of the current frame, respectively, by fusing the binocular feature of at least one of the frames prior to the mapped current frame with the binocular feature of the current frame may further include the following operations.

According to an embodiment, the method may further include an operation acquiring the fused binocular feature corresponding to the current frame by fusing the binocular feature of the at least one mapped frame with the binocular feature of the current frame.

According to an embodiment, the fused binocular feature may mean a feature output by the multi-frame feature fusion module of FIG. 13 or 14, but the disclosure is not limited thereto, and as such the fuse binocular feature may be acquired in other ways.

According to an embodiment, the method may further include an operation generating, based on the fused left-eye feature corresponding to the current frame and the third depth map of at least one frame prior to the current frame, a fifth depth map of the current frame and a first mask. The first mask may include a correspondence relationship between a different region of the third depth map of the current frame and the depth map of the frame different from the current frame. The method may further include an operation generating, based on the fused right-eye feature corresponding to the current frame and the fourth depth map of at least one frame prior to the current frame, a sixth depth map of the current frame and a second mask. The second mask may include a correspondence relationship between a different region of the fourth depth map of the current frame and the depth map of the frame different from the current frame.

For example, based on the fusion binocular features at time T and the left-eye and right-eye high-resolution depth maps output at time (T−1), the left-eye processing is performed as an example to generate the high-resolution fifth depth map and the high-resolution first mask of the left-eye at time T. The mask learns which region should be updated to the depth at time T and which region should maintain the depth at time (T−1). According to an embodiment, right-eye processing may also be performed in the same or similar manner as left-eye processing.

According to an embodiment, the method may further include acquiring a third image of the current frame by fusing the fifth depth map of the current frame and the third depth map of the at least one frame based on the first mask, and acquiring a fourth image of the current frame by fusing the sixth depth map of the current frame and the fourth depth map of the at least one frame based on the second mask.

In an example case in which the left-eye processing is performed using a dynamic binocular mask, the high-resolution third depth map of the left-eye at time (T−1) and the high-resolution fifth depth map of the left-eye at time T are subjected to weighted mixing, and the final high-resolution third depth map of the left-eye at time T is output. According to an embodiment, right-eye processing may also be performed in the same or similar manner as left-eye processing.

In an embodiment, consistency on a plurality of frame time sequences may be improved by using time-space information of a binocular depth map of at least one previous frame.

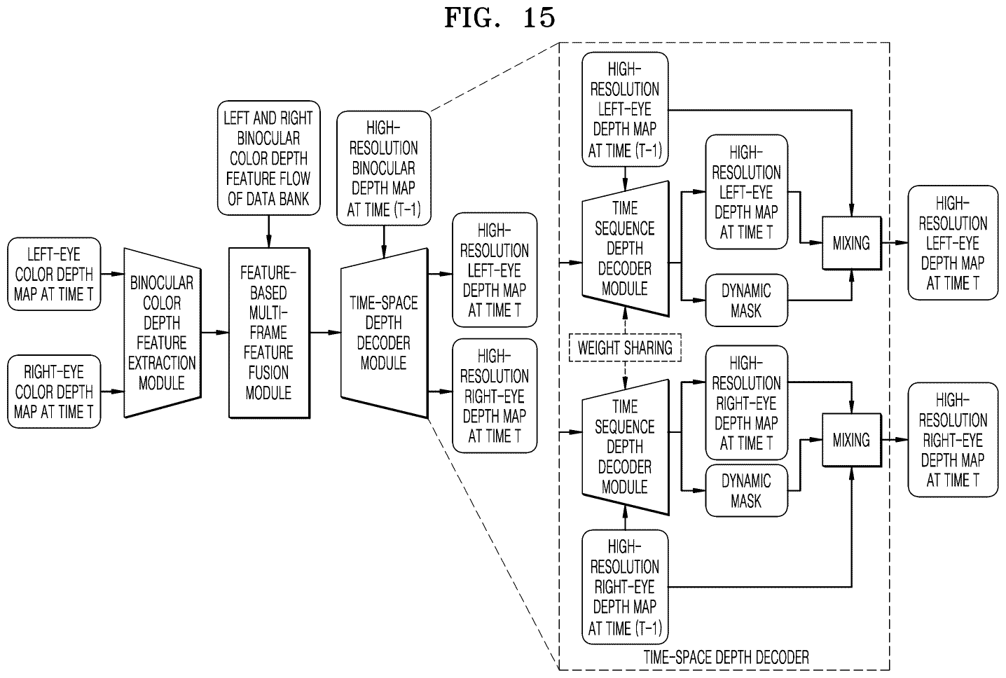

For example, in an embodiment, a lightweight level time-space depth decoder module-based video depth super-resolution model capable of real-time driving may be provided, and as shown in FIG. 15, the model includes a module for extracting depth features for binocular colors (e.g., the feature extraction module and/or cross-attention network), a feature-based multi-frame feature fusion module, and a time-space depth decoder module.

According to an embodiment, feature extraction is performed for a current right-eye image (for example, a right-eye color map and a right-eye second depth map at time T) and a current left-eye image (for example, a left-eye color map and a left-eye first depth map at time T) through the binocular color depth feature extraction module to acquire a current binocular feature. After passing through a multi-frame feature fusion module together with the feature flow stored in the memory bank, the fused feature and the high-resolution binocular depth map at time (T−1) are entered together into the space-time depth decoder module.

In the space-time depth decoder module, in the case of left-eye processing, one space-time depth decoder outputs a high-resolution left-eye depth map at time T and a dynamic mask of the left-eye (e.g., a first mask), performs weighted mixing on the high-resolution left-eye depth map at time (T−1) and the high-resolution left-eye depth map at time T, and outputs a final high-resolution left-eye depth map at time T. According to an embodiment, the right-eye processing operation may be same as the left-eye processing operation. According to an embodiment, the left-eye and the right-eye may share one space-time depth decoder.

According to an embodiment, the space-time depth decoder module may replace the depth reconfiguration module among the BVDSR models to construct a new model.

Considering that the limit of the visible refresh rate to the human eye is about 200 Hz, XR devices require a higher frame rate for a better user experience, and the processing of depth information puts more computational burden on the device, especially in an example case in which depth information is directly processed on XR devices. Therefore, in an embodiment, provided is a method of improving a temporal resolution, which may be used alone or simultaneously with a method of improving a spatial resolution.

According to an embodiment, a method executed by an electronic device according to an embodiment may include the following operations.

According to an embodiment, the method may further include the method may include acquiring first motion information from at least one of frames prior to a current frame to the current frame.

According to an embodiment, the first motion information may mean motion information output from the optical flow estimation network of FIG. 13 or the implicit estimation network of FIG. 14, but is not limited thereto and may be acquired in other ways.

According to an embodiment, the method may further include acquiring second motion information from the current frame to a first time by sampling the first motion information. For example, the first time may mean a time when a time of a first interval has elapsed from the current frame.

For example, motion sampling samples the second motion information of extrapolated time (e.g., first time) T+A on the first motion information of the current multiple frames. Here, Δt represents the first interval.

In an embodiment, the first interval does not exceed a time interval between two consecutive frames. In other words, the Δt is one value between 0 and 1, and one of ordinary skill in the art may set the Δt according to the actual situation, for example, Δt=0.5, etc., and embodiments are not limited thereto.

According to an embodiment, the method may further include, based on the second motion information, mapping the third depth map, the fourth depth map, the first image, and the second image of the current frame to the first time to acquire the third depth map, the fourth depth map, the first image, and the second image of the first time.

For example, on the sampled second motion information, the color map and depth map at the time T are mapped to the time (T+Δt) to acquire the color map and depth image at the time (T+Δt).

In an embodiment, motion information at a first time may be implemented by extrapolating motion information by calculating a motion vector. Based on this, a binocular image having a high-resolution at a current time may be converted into a binocular image having a high-resolution at a first time.

In an embodiment, the binocular image may be further subdivided by aggregating information on past feature flows. For example, the optional implementation method may include the following operations.

According to an embodiment, the method may further include, based on the second motion information, mapping the third depth map, the fourth depth map, the first image, and the second image of the current frame to the first time to acquire the seventh depth map, the eighth depth map, the third image, and the fourth image of the first time.

For example, on the sampled second motion information, the color map and depth map at the time T are mapped to the time (T+Δt) to acquire the color map and depth image of the initial time (T+Δt).

According to an embodiment, the method may further include, based on at least one of the current frame and previous frames, optimizing the seventh depth map, the eighth depth map, the third image, and the fourth image of the first time to acquire the third depth map, the fourth depth map, the first image, and the second image of the first time.

For example, feature flow information stored in the memory bank is combined, and the color map and depth map of the initial time (T+Δt) are further optimized to generate final high-resolution color maps and depth maps at the time (T+Δt).

According to an embodiment, in the case of XR, the module executing the sixteenth to eighteenth operations may be referred to as an extrapolation module, and may specifically be an RGBD extrapolation module.

In an embodiment, the BVDSR module may be combined with an extrapolation module, and its purpose is to improve the service for the XR application by simultaneously improving the spatial resolution and temporal resolution of the depth map.

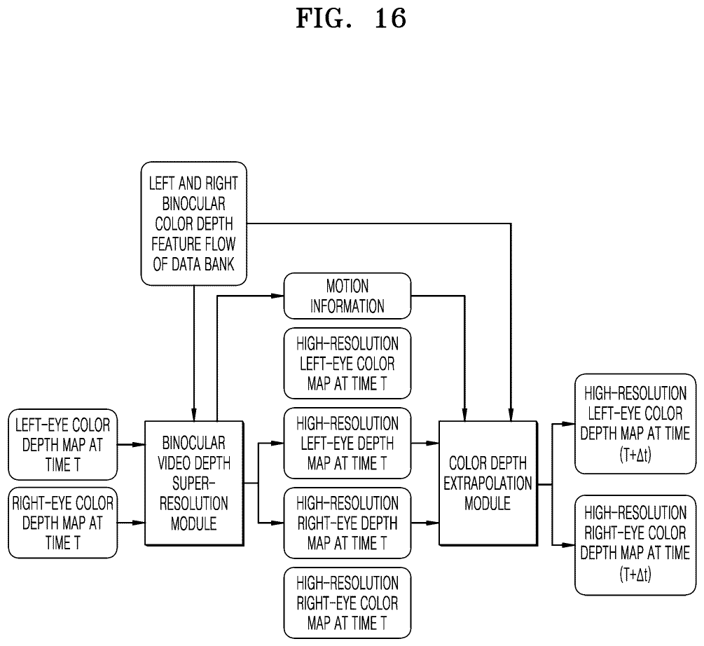

For example, in an embodiment, a video depth super-resolution model combined with a lightweight level extrapolation module capable of real-time driving may be provided, and as shown in FIG. 16, the model includes a depth super-resolution module (e.g., the aforementioned BDSR module, BRDSR module, BVDSR module, or the like, which is collectively referred to as a binocular video depth super-resolution module in FIG. 16), and a color depth extrapolation module.

Specifically, for the current right-eye image (e.g., the right-eye color map and the right-eye second depth map at time T) and the current left-eye image (e.g., the left-eye color map and the left-eye first depth map at time T), the left and right binocular image color feature flows stored in the memory bank are combined. Current binocular second depth features (e.g., high-resolution, left and light binocular depth images at time T) and motion information are outputs through a binocular video depth super-resolution module. The current binocular depth image (for example, high-resolution left and right binocular depth maps at time T), the current binocular color image (for example, high-resolution left and right binocular color maps at time T), motion information, and the left and right binocular color depth feature flows stored in a memory are entered into the color depth extrapolation module together. After the first interval, a binocular depth map at the first time (for example, high-resolution left and right binocular depth maps at T+Δt) and a binocular color image (for example, high-resolution left and right binocular color maps at T+Δt) are output.

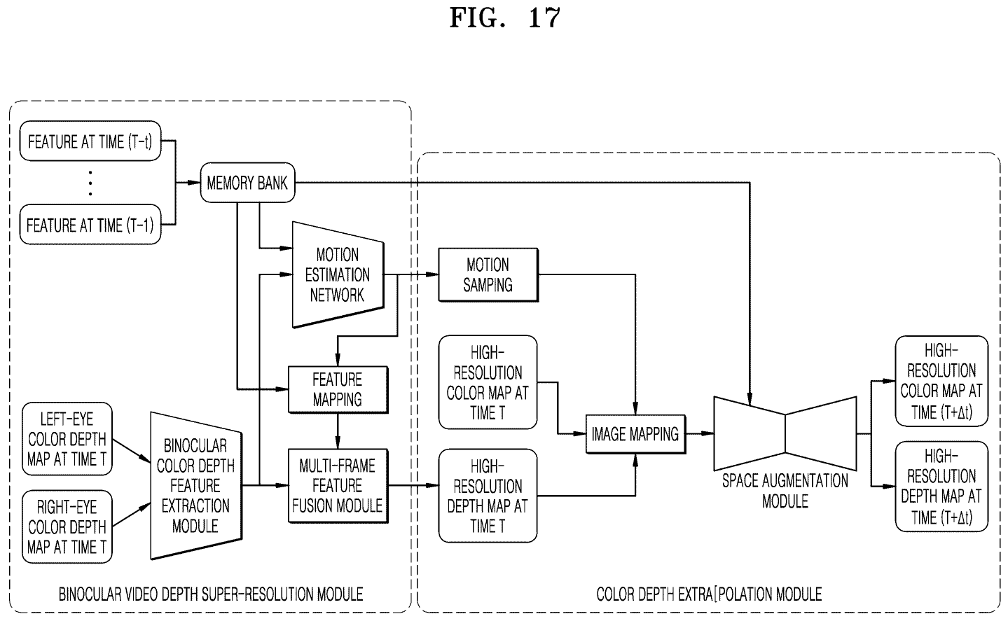

In an embodiment, the extrapolation module may include a motion sampling module, an image mapping module, and a space augmentation module to implement motion-based changes. For example, another video depth super-resolution model that is combined with an extrapolated module may be as illustrated in FIG. 17, Feature extraction is performed for a current right-eye image (for example, a right-eye color map and a right-eye second depth map at time T) and a current left-eye image (for example, a left-eye color map and a left-eye first depth map at time T) through the binocular color depth feature extraction module to acquire a current binocular feature. After training the motion information between feature flows through the past features (e.g., features at time (T−1), . . . , features at time (T-t)) stored in the memory bank of multiple frames and motion estimation networks (e.g., implicit estimation network), multi-frame features are projected onto the current frame based on the trained motion information. After projection, the switched features of a plurality of frames are dynamically fused via a multi-frame feature fusion module to output a current (e.g., at time T) high-resolution binocular depth map.

The motion information of extrapolated time (e.g., at time (T+Δt)) on the motion information of the current multiple frames are sampled through a motion sampling module. Through an image mapping module, the color map and depth map at present (e.g., at time (T+Δt)) are mapped to extrapolated time (e.g., time (T+Δt)), on the sampled motion information. The color map and depth map of the initial extrapolation time (e.g., time (T+Δt)) are acquired, and then, the feature flow information stored in a memory bank is combined through a lightweight space augmentation module. The output results of the image mapping module are further optimized to generate final high-resolution color maps and depth maps at the extrapolation time (e.g., at time (T+Δt)).

In an embodiment, the depth super-resolution model and the video extrapolation module of the at least one embodiment described above are combined to form a single model, and the two modules are combined by adding motion-based transformations to enable the model to not only output a high-resolution depth map, but also to improve the frame rate of the output binocular image (e.g., a high-resolution color depth map), thereby simultaneously improving the depth spatial resolution and the temporal resolution of the color depth map, further reducing the inter-frame delay and providing a seamless XR video experience for users. According to an embodiment, the model may perform learning end-to-end.

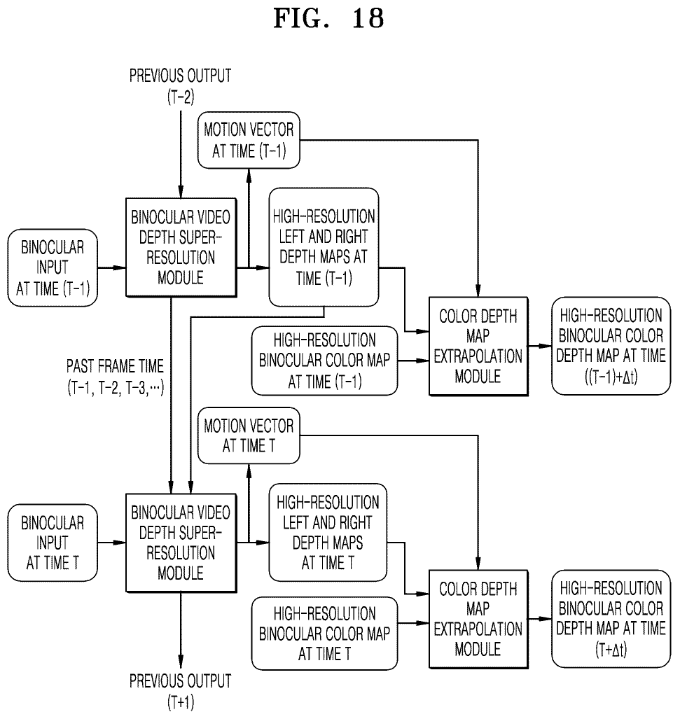

Based on the at least one embodiment, a complete flow example of a depth super-resolution method for an XR device is provided according to an embodiment. As shown in FIG. 18, the complete flow example of a depth super-resolution method for an XR device may include the following operations: (1) a binocular depth super-resolution model may be implemented based on a model in which cross-view interacts, thereby simultaneously processing binocular inputs and outputting binocular high-resolution maps; (2) based on an online binocular video depth super-resolution model of interaction between a cross-view and a time sequence, binocular input time sequences may be processed without relying on future frames; and (3) based on a network that combines binocular video depth super-resolution of motion transformation with color depth extrapolation modules, the depth spatial resolution and the temporal resolution of color depth maps may be improved simultaneously.

According to an embodiment, the binocular input includes a left-eye high-resolution color map (e.g., a first image), a left-eye low-resolution depth map (e.g., a first depth map), a right-eye high-resolution color map (e.g., a second image), and a right-eye low-resolution depth map (e.g., a second depth map).

Here, at time T, binocular input is combined with features of past frames (e.g., time (T−1), time (T−2), . . . ) (e.g., intermediate output results from a binocular video depth super-resolution module at time (T−1), and used to fuse multi-frame information to ensure time sequence consistency of multi-frames), and high-resolution left and right depth maps at time (T−1) (e.g., used to improve consistency on multi-frame time sequences by decoding using time-space information at time (T−1)), through a binocular video super-resolution module, and output as left-eye high-resolution depth maps (e.g., third-depth maps) and right-eye high-resolution depth maps (e.g., fourth-depth maps), which may also be called binocular high-resolution depth maps.

A color depth map extrapolation module receives, as inputs, a high-resolution left-eye color depth map at time T, a high-resolution right-eye color depth map at time T, and motion information at time T (e.g., used to sample motion information at an extrapolation time), and the above module outputs a high-resolution left-eye color depth map at time (T+Δt) (e.g., a specific time in the middle from time T to time (T+1)) and a high-resolution right-eye color depth map at time (T+Δt).

According to an embodiment, a process flow of past frames such as at time (T−1) and time (T−2), and a process flow of future frames such as at time (T+1) and time (T+2) may also be performed in the same or similar manner, and thus, a detailed description thereof will be omitted.

The depth super-resolution method provided in an embodiment is used in systems such as AR and MR, performs real-time supplementation and super-resolution realization on depth information (which may be image- or video-based) of a user environment, and outputs environmental depth and color information with high-resolution and high frame rate. For example, the depth super-resolution method provided in an embodiment may be used for pass-through of video see-through (VST), which creates a view with a high frame rate and no distortion deformation, to thereby improve the user's visual experience. In another example, the depth super-resolution method provided in an embodiment may be used for VR fusion and interaction, which may more practically combine virtual objects with the environment and support real-time interaction.

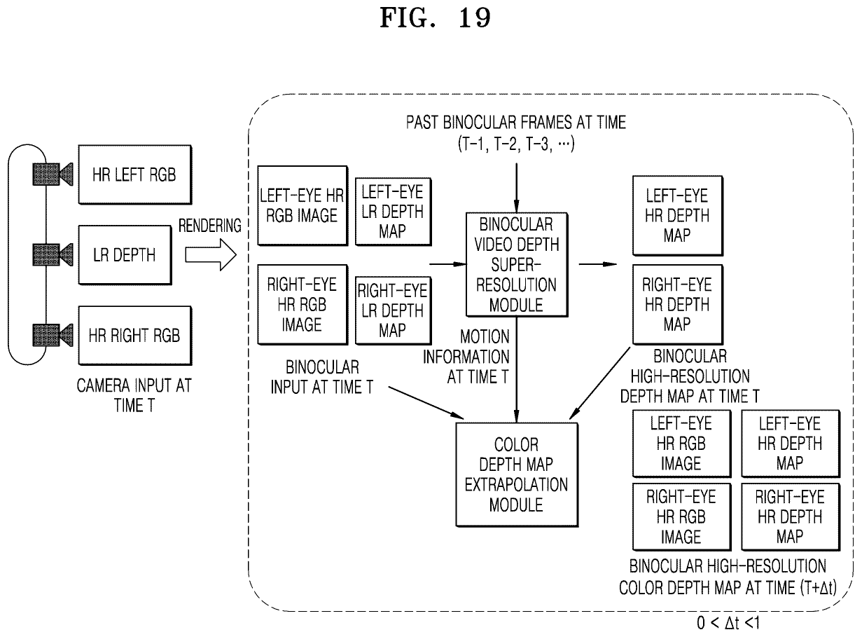

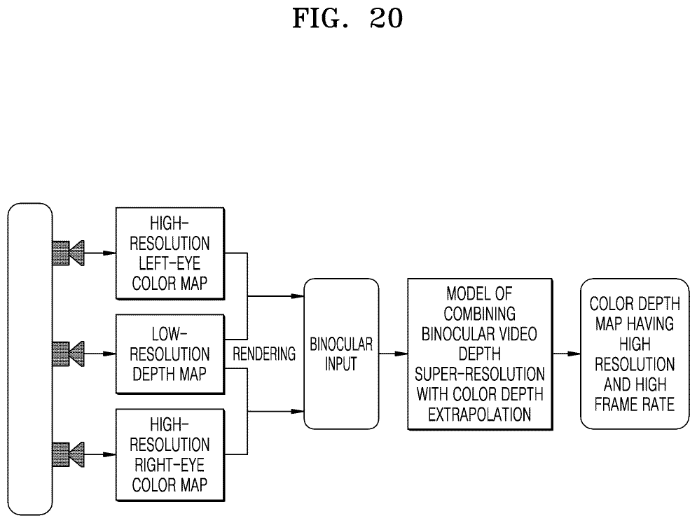

In an embodiment, two example scenarios in which a method according to an embodiment of the disclosure is applied to an XR system are provided. As illustrated in FIGS. 19 and 20, a high-efficiency process flow based on RGBD and RGBD frame extrapolation may be implemented. According to an embodiment, a HR left RGB image, a high-resolution (HR) right RGB image, and a low-resolution (LR) depth map are collected by multiple cameras on a head mounted XR device. The HR left-eye RGB image and the LR depth map are processed (or rendered) to acquire a pair of a HR left-eye RGB image and a LR left-eye depth map, and the HR right-eye RGB image and the LR depth map are processed (or rendered) to acquire a pair of a HR right-eye RGB image and a LR right-eye depth map, which are input into an XR system as a binocular image. In a model combining a binocular video depth super-resolution module with a color depth extrapolation module deployed in the XR system, the binocular video depth super-resolution module may combine a binocular input at time T with past binocular frames (e.g., at time (T−1), time (T−2), time (T−3), etc.), output the HR left-eye depth map, the HR right-eye depth map, and the motion information at time T, and then output the binocular color depth map having the high-resolution and the high frame rate at time (T+Δt) through the color depth extrapolation module along with the binocular input at time T.

Here, the binocular RGBD output with higher frame rates and high-resolution allows XR devices to provide a more realistically rich user's feeling experience with higher image quality and refresh rates, such as high frame rates, deformation-free passthrough effects, and realistic VR interaction experiences.

In an experimental test, in which, data with only parallax and removed depth holes and data with more depth holes were applied as input into an XR processing method according to an embodiment of the disclosure, more accurate HR depth maps were predicted, fewer depth errors were observed, and the processing speed of was further increased especially in an example case in which there are more depth lost regions in the input depth map.

In an embodiment, an electronic device is further provided. Here, the electronic device may include a processor. According to an embodiment, the electronic device may further include a transceiver and/or a memory coupled to the processor, and the processor is configured to execute the operations of the method provided in one or more embodiments of the disclosure.

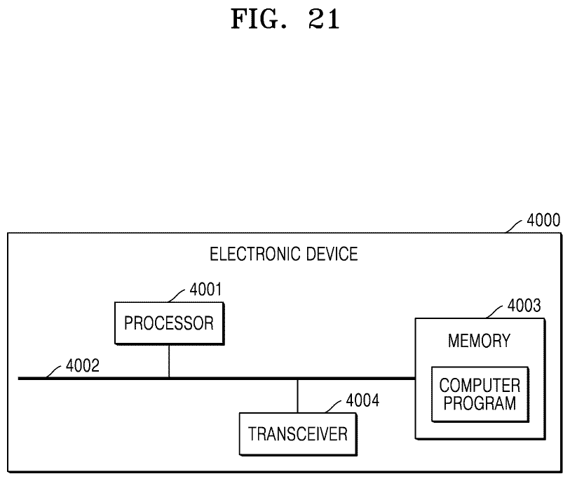

FIG. 21 is a structural diagram of an electronic device that may be applied according to an embodiment. As illustrated in FIG. 21, an electronic device 4000 illustrated in FIG. 21 includes a processor 4001 and a memory 4003. Here, the processor 4001 and the memory 4003 are connected to each other through a bus 4002 or the like. According to an embodiment, the electronic device 4000 may further include a transceiver 4004, which may be used for data exchange, such as data transmission and/or data reception between the electronic device and other electronic devices. In an actual application, the number of transceivers 4004 is not limited to one, and the structure of the electronic device 4000 does not limit the embodiment of the disclosure. According to an embodiment, the electronic device 4000 may be a first network node, a second network node, or a third network node.

The processor 4001 may be a CPU, a general-purpose processor, a digital signal processor (DSP), an application specific integrated circuit (ASIC), a field programmable gate array (FPGA), or other programmable logic devices, transistor logic devices, hardware components, or any combination thereof. To this end, various logic blocks, modules, and circuits described in the disclosure may be implemented or executed. The processor 4001 may be a combination that implements a computing function, such as a combination of one or more microprocessors, a combination of a DSP and a microprocessor, and the like.

The bus 4002 may include one path, and transmits information between the components described above. The bus 4002 may be a peripheral component interconnect (PCI) bus, an extended industry standard architecture (EISA) bus, or the like. The bus 4002 may be classified into an address bus, a data bus, a control bus, and the like. For convenience of expression, only one thick line is used in FIG. 21, but this does not mean that there is only one bus or one type of bus.

The memory 4003 may be read-only memory (ROM) or another type of static storage device capable of storing static information and commands, random-access memory (RAM), or another type of dynamic storage device capable of storing information and commands, and may be electrically erasable and programmable read only memory (EEPROM), a compact disc read only memory (CD-ROM), or other compact disc storage, optical disc storage (including compressed optical discs, laser discs, optical discs, digital general-purpose optical discs, Blu-ray optical discs, or any other computer-readable medium that may be used to carry or store computer programs, but is not limited thereto.

The memory 4003 is used to store a computer program executing an embodiment, and is controlled and executed by the processor 4001. The processor 4001 is used to execute a computer program stored in the memory 4003, and implements the operations according to the method of the embodiment.

In an embodiment, a computer program-readable storage medium in which a computer program is stored, is further provided and when the computer program is executed by the processor, the operations of the method of the embodiment and corresponding features may be implemented.

In an embodiment, a computer program product in which a computer program is stored, is further provided and when the computer program is executed by the processor, the operations of the method of the embodiment and corresponding features may be implemented.

The terms “first”, “second”, “third”, “four”, “one”, “two”, etc. (if present) in the specification and claims of this disclosure and the accompanying drawings are intended to distinguish similar objects from others and are not necessarily used to describe a specific order or back-and-forth order. The data used herein may be mutually compatible in appropriate circumstances. Therefore, it should be understood that embodiments described herein may be implemented in a different order than those illustrated or described in texts.

According to one or more embodiments, various operations and/or functions described above may be implemented in a hardware approach. For example, according to some embodiments, the methods described above may be implemented by an electronic device configured to carry out a described operation(s) or function(s). The electronic device may include blocks, which may be referred to herein as managers, units, modules, hardware components, “˜er” terms or the like, may be physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure. However, the disclosure is not limited thereto, and as such, the blocks, which may be referred to herein as managers, units, modules, or the like, may be software modules implemented by software codes, program codes, software instructions, or the like. The software modules may be executed on one or more processors. According to an embodiment, the “module” may be a minimum unit of an integrally formed component or part thereof. The “module” may be a minimum unit for performing one or more functions or part thereof. The “module” may be implemented mechanically or electronically.

Although each operation is indicated by arrows in the flowchart of the embodiment, it should be understood that the execution order of these operations is not limited to the order indicated by arrows. Unless explicitly stated herein, in some implementation scenarios of the embodiments, the implementation operations of each flowchart may be executed in a different order as necessary. In addition, some or all operations of each flowchart are based on an actual implementation scenario, and may include a plurality of sub-operations or a plurality of procedures. Some or all of these sub-operations or procedures may be executed simultaneously, and each of these sub-operations or procedures may be executed at different times. In scenarios with different execution times, the execution order of these sub-operations or procedures may be flexibly configured as needed, and embodiments of the disclosure are not limited thereto. For example, in some embodiments, one or more operations may be omitted and/or one or more additional operations may be added.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A method performed by an electronic device, the method comprising:
acquiring a binocular image comprising a left-eye image and a right-eye image, the left-eye image comprising at least one of a first image and a first depth map, and the right-eye image comprising at least one of a second image and a second depth map;
generating a third depth map based on the left-eye image and a correlation between the left-eye image and the right-eye image, and generating a fourth depth map based on the right-eye image and the correlation between the left-eye image and the right-eye image; and
performing extended reality (XR) processing on the binocular image based on the third depth map and the fourth depth map,
wherein a resolution of the third depth map is greater than a resolution of the first depth map, and a resolution of the fourth depth map is greater than a resolution of the second depth map.

2. The method of claim 1, wherein the generating the third depth map and the fourth depth map comprises:
acquiring a left-eye feature by performing feature extraction on the left-eye image, and acquiring a right-eye feature by performing feature extraction on the right-eye image;
acquiring attention weights using a cross-attention network based on the left-eye feature and the right-eye feature, the attention weights indicating a semantic relationship between the left-eye image and the right-eye image,
performing a first augmentation processing on the left-eye feature based on the attention weights to obtain an augmented left-eye feature and a second augmentation processing on the right-eye feature based on the attention weights to obtain an augmented right-eye feature; and
generating the third depth map based on the augmented left-eye feature, and generating the fourth depth map based on the augmented right-eye feature.

3. The method of claim 2, wherein the acquiring the attention weights, the performing the first augmentation processing and the second augmentation processing comprise:
determining a first related pixel from the left-eye feature based on at least one of the second depth map and a right-eye parallax map, acquiring a first related feature based on the determined first related pixel, determining a second related pixel from the right-eye feature based on at least one of the first depth map and a left-eye parallax map, and acquiring a second related feature based on the determined second related pixel;
acquiring a first attention weight using a cross-attention network based on the first related feature and the right-eye feature, and acquiring a second attention weight using the cross-attention network based on the second related feature and the left-eye feature; and
performing the second augmentation processing on the right-eye feature based on the first attention weight, and performing the first augmentation processing on the left-eye feature based on the second attention weight.

4. The method of claim 3, wherein the performing the first augmentation processing and the second augmentation processing comprise:
determining a pixel non-shielding region of the right-eye feature based on the first attention weight, and determining a pixel non-shielding region of the left-eye feature based on the second attention weight; and
performing an augmentation process on the pixel non-shielding region of the right-eye feature based on the first attention weight, and performing an augmentation process on the pixel non-shielding region of the left-eye feature based on the second attention weight.

5. The method of claim 1, wherein the generating the third depth map and the fourth depth map comprises:
generating a binocular feature of a current frame based on the correlation, the left-eye image, and the right-eye image for the current frame, the binocular feature comprising the left-eye feature and the right-eye feature;
determining motion information between a plurality of frames based on a binocular feature of at least one of the current frame and frames prior to the current frame;
mapping, based on the motion information, a binocular feature of at least one frame prior to the current frame to the current frame; and
generating the third depth map and the fourth depth map for the current frame by fusing a binocular feature of the mapped at least one frame with a binocular feature of the current frame.

6. The method of claim 5, wherein the motion information between the plurality of frames is determined by using an optical flow estimation network.

7. The method of claim 5, wherein the motion information between the plurality of frames is determined by using an implicit estimation network.

8. The method of claim 5, wherein the generating the third depth map and the fourth depth map for the current frame by fusing the binocular feature of the mapped at least one frame with the binocular feature of the current frame, comprises:
acquiring a fusion binocular feature corresponding to the current frame by fusing the binocular feature of the at least one mapped frame with the binocular feature of the current frame, the fusion binocular feature comprising a fusion left-eye feature and a fusion right-eye feature;
generating, based on the fusion left-eye feature corresponding to the current frame and the third depth map of the at least one frame among the frames prior to the current frame, a fifth depth map of the current frame and a first mask, the first mask comprising a different region of the third depth map of the current frame and a correspondence relationship between a depth map of the current frame and a depth map of a different frame;
generating, based on the fusion right-eye feature corresponding to the current frame and the fourth depth map of the at least one frame among the frames prior to the current frame, a sixth depth map of the current frame and a second mask, the second mask comprising a different region of the fourth depth map of the current frame and a correspondence relationship between a depth map of the current frame and a depth map of a different frame; and
acquiring a third image of the current frame by fusing the fifth depth map of the current frame and the third depth map of the at least one frame based on the first mask, and acquiring a fourth image of the current frame by fusing the sixth depth map of the current frame and the fourth depth map of the at least one frame based on the second mask.

9. The method of claim 1, further comprising:
acquiring first motion information from at least one of the frames prior to a current frame to the current frame;
acquiring second motion information from the current frame to a first time by sampling the first motion information; and
acquiring the third depth map of the first time, the fourth depth map of the first time, the first image of the first time, and the second image of the first time, by mapping, based on the second motion information, the third depth map of the current frame, the fourth depth map of the current frame, the first image of the current frame, and the second image of the current frame, to the first time, wherein the first time is a time when a time of a first interval has elapsed from the current frame.

10. The method of claim 9, wherein the acquiring of the third depth map of the first time, the fourth depth map of the first time, the first image of the first time, and the second image of the first time, by mapping, based on the second motion information, the third depth map of the current frame, the fourth depth map of the current frame, the first image of the current frame, and the second image of the current frame, to the first time, comprises:
acquiring a fifth depth map, a sixth depth map, the first image of the first time, a third image of the first time, and a fourth image of the first time, by mapping, based on the second motion information, the third depth map of the current frame, the fourth depth map of the current frame, the first image of the current frame, and the second image of the current frame, to the first time; and
acquiring the third depth map of the first time, the fourth depth map of the first time, the first image of the first time, and the second image of the first time, by optimizing, based on the current frame and at least one frame of the frames prior to the current frame, the fifth depth map, the sixth depth map, the third image of the first time, and the fourth image of the first time.

11. The method of claim 9, wherein the first interval does not exceed a time interval between consecutive frames.

12. The method of claim 2, wherein the cross-attention network is trained based on at least one loss function among a consistency-related loss function of the third depth map and the fourth depth map and a consistency-related loss function of the left-eye feature and the right-eye feature.

13. The method of claim 1, wherein the performing of the XR processing comprises performing at least one of augmented reality processing, mixed reality processing, video see-through processing, or virtual reality fusion processing.

14. An electronic device comprising:
memory storing one or more instructions, and
a processor configured to execute the one or more instructions, wherein the one or more instructions, when executed by the processor, configured to:
acquire a binocular image comprising a left-eye image and a right-eye image, the left-eye image comprising at least one of a first image and a first depth map, and the right-eye image comprising at least one of a second image and a second depth map;
generate a third depth map based on the left-eye image and a correlation between the left-eye image and the right-eye image, and generating a fourth depth map based on the right-eye image and the correlation between the left-eye image and the right-eye image; and
perform extended reality (XR) processing on the binocular image based on the third depth map and the fourth depth map,
wherein a resolution of the third depth map is greater than a resolution of the first depth map, and a resolution of the fourth depth map is greater than a resolution of the second depth map.

15. The electronic device of claim 14, wherein the processor is configured to:
acquire a left-eye feature by performing feature extraction on the left-eye image, and acquire a right-eye feature by performing feature extraction on the right-eye image;
acquire an attention weight using a cross-attention network based on the left-eye feature and the right-eye feature, the attention weight indicating a semantic relationship between the left-eye image and the right-eye image;
perform a first augmentation processing on the left-eye feature based on the attention weight to obtain an augmented left-eye feature and a second augmentation processing on the right-eye feature based on the attention weight to obtain an augmented right-eye feature;
generate the third depth map based on the augmented left-eye feature; and
generate the fourth depth map based on the augmented right-eye feature.

16. The electronic device of claim 14, wherein the processor is configured to:
acquire first motion information from at least one of the frames prior to a current frame to the current frame;
acquire second motion information from the current frame to a first time by sampling the first motion information; and
acquire the third depth map of the first time, the fourth depth map of the first time, the first image of the first time, and the second image of the first time, by mapping, based on the second motion information, the third depth map of the current frame, the fourth depth map of the current frame, the first image of the current frame, and the second image of the current frame, to the first time,
wherein the first time is a time when a time of a first interval has elapsed from the current frame.

17. A non-transitory computer readable storage medium having a computer program stored thereon to implement the method of claim 1 when the computer program is implemented by a processor.

18. A non-transitory computer program product comprising a computer program, which implements the method of claim 1 when the computer program is implemented by a processor.
